(19) United States
(12) Patent Application Publication
(10) Pub. No.: US 2001/0018768 A1
(43) Pub. Date: Aug. 30, 2001

(54) Information processing device for network system, a method thereof and recording medium recorded a program for such method

(76) Inventors: Mari Horiguchi, Tokyo (JP); Makoto Sato, Tokyo (JP)

Correspondence Address: FROMMER LAWRENCE & HAUG LLP, 745 FIFTH AVENUE, NEW YORK, NY, 10151, US

(21) Appl. No.: 09/794,970

(22) Filed: Feb. 27, 2001

(30) Foreign Application Priority Data
Feb. 29, 2000 (JP) P2000-053099

(51) Int. Cl. H04N 7/18

(52) U.S. Cl. 725/80; 725/78

(57) ABSTRACT

Analog connections between plural electronic devices in an integrated digital network system connected via the IEEE-1394 bus can be easily recognized according to the invention. A DVHS requests an IRD, which are connected to the IEEE-1394 bus, to read the object entry which describes the object ID of an oEXT of the IRD (step 21). The IRD opens the plug descriptor stored therein (step 32). Then, the IRD reads out the contents of the object entry which describes the object ID of the oEXT from the plug descriptor opened in step 32, and transfer the contents thereof to the DVHS (step 33). The DVHS is allowed to recognize the status of analog connections from the contents of the object entry thus transferred (step 23).

### BACKGROUND OF THE INVENTION

1. Field of the Invention

The present invention relates to an information processing device for network system, a method thereof and a recording medium recorded a program for such method, and accordingly this invention is able to execute a control of an analog connection status to be substantially easy in a so-called home network system.

2. Description of the Related Art

A so-called home network system (hereinafter referred to as the IEEE-1394 network system) can be constructed by connecting electronic devices such as a reproducing device, a recording device and/or a receiver device, each of these devices including a digital interface of the IEEE-1394 Standard (hereinafter referred to as the IEEE-1394 I/F), to a digital bus of the IEEE-1394 Standard (hereinafter referred to as the IEEE-1394 bus).

This IEEE-1394 I/F executes a digital interface processing according to a CSR (Control & Status Register) architecture which has a 64-bit address space specified by the ISO/IEC-13213 as shown in FIG. 1.

In an upper 16-bit address space (A) of this 64-bit address space, there is described a node Id for identifying each node (namely, each electronic device) on the IEEE-1394 bus. Further, these upper 16 bits are divided into two parts of 10 bits for a bus ID and 6 bits for a physical ID. A value in case all bits in this upper 16 bits become “1” is used for a special purpose, therefore, by utilizing the upper 16-bit address space, 1023 buses and 63 nodes can be specified.

Lower 48-bit spaces (B) and (C) in FIG. 1 are utilized for designation of address spaces given to each node.

An address space specified by its upper 20 bits among this lower 48-bit address space (B) is divided into an initial memory space, a private space an initial register space and the like.

For example, if its 20-bit is the initial register space, the lowest 28 bits include, as indicated in FIG. 1, the CSR architecture, a serial bus, a configuration ROM (Read Only Memory), an initial unit space, a plug control register (PCR) and the like.

In the configuration ROM, there are described various pieces of information in accordance with a general ROM (Read Only Memory) format.

FIG. 2 shows each example of a bus_infoblock, a root_directory, and an unit_directory described in the configuration ROM.

For example, a Company_ID stored in the bus_infoblock indicates an ID of a manufacturer of its electronic device, and a Chip_ID therein indicates an unique ID of its electronic device which is specific thereto and does not duplicate with that of any other electronic device in the world. By way of example, these Company_ID and the Chip_ID, both inclusive are referred to as a GUID (Global Unique ID).

Now, back to FIG. 1, the initial unit space therein is used for a particular purpose unique to the node.

In the PCRs in FIG. 1, the PCRs specified in the IEC-1883 Standards are described. This PCR embodies a concept of connecting plugs that forms a digital signal path logically similar to an analog interface between connecting objects.

The PCR includes an oPCR (output Plug Control Register) which indicates an output plug for an isochronous transfer, an iPCR (input Plug Control Register) which indicates an input plug for the isochronous transfer, and the like. The oPCR and the iPCR have a data configuration as shown in FIGS. 3A and 3B.

An On-line in the MSB (Most Significant Bit) of the oPCR (FIG. 3A) and the iPCR (FIG. 3B) indicates a status of use of the connecting plug. Namely, if its value of the On-line is “1”, it indicates that the plug is in ON-LINE state, and if its values is “0”, it indicates that the plug is in OFF-LINE state. A broadcast connection counter in the oPCR and the iPCR indicates a presence (1) or an absence (0) of its broadcast connection. A point-to-point connection counter in the oPCR and the iPCR indicates the number of the point-to-point connections to be done by the plug. Channel numbers in the oPCR and the iPCR indicate the number of the isochronous channels to which its plug is connected.

A data rate in the oPCR indicates an actual transfer rate of the isochronous packets at which they are output from its plug. An overhead ID in the oPCR indicates a bandwidth per overhead of an isochronous communication. A payload in the oPCR indicates a maximum value of data contained in the isochronous packets that its plug can handle.

Because the IEEE-1394 I/F executes the digital interface processing in accordance with the CSR architecture as described above, it is enabled easily to recognize a connection relationship between electronic devices that constitute an IEEE-1394 network system.

For example, in case a given electronic device X that constitutes the IEEE-1394 network system is requested to specify another electronic device Y to be associated therewith that also constitutes the IEEE-1394 network system, the electronic device X reads out PCR information of respective electronic devices that are connected to the IEEE-1394 network system to detect specified proper electronic device Y that has an iPCR with the same channel number as the channel number of the oPCR of an object of interest. Then, the electronic device X obtains the GUID of the electronic device Y thus detected, which the GUID is described in its configuration ROM. Thereby, it is ensured to recognize that the proper electronic device which is to be connected to the output plug of the object of interest is the electronic device Y. As described above, in the IEEE-1394 network system, the connection relationship between respective electronic devices can be recognized easily.

However, in the case where the electronic devices constituting the IEEE-1394 network system are connected also via an analog signal line, namely, in the case where analog signals are exchanged therebetween, these electronic devices further comprise an analog interface for controlling input and output of analog signals (hereinafter referred to as analog I/F). This analog I/F, however, cannot obtain information necessary to specify a proper electronic device and/or a proper analog I/O terminal therefor. Namely, the analog I/F is not able to control connection status of the analog connections. As a result, when the user desires to switch over, for example, the analog signal I/O connecting plugs, the user must confirm by oneself which electronic device is connected to which the analog signal input plug, then perform change-over of the analog signal I/O plugs by operating, for example, an I/O change-over switch or the like. Thereby, there is a problem that very complicated time-consuming procedures are required.

The present invention has been contemplated to solve such problems described above and to provide for an information processing system which is easily capable of controlling connection relations between analog signal input and output connecting plugs.

### SUMMARY OF THE INVENTION

A first information processing device according to the invention is comprised of: an I/O control unit for controlling an input and/or an output of an analog signal to be exchanged between the same and a first another information processing device which are connected via an analog signal line; a memory unit for storing ID information for identifying the I/O control unit, and a global unique ID of the first another information processing device, associated therebetween; and a supply unit for supplying the global unique ID of the first another information processing device stored in the memory unit to a second another information processing device in response to its request.

The memory unit thereof is able to further store a text corresponding to the I/O control unit.

A digital network thereof may be comprised of an IEEE-1394 digital serial bus.

The memory unit thereof may be comprised of descriptors specified by AV/C (Audio, Visual and Computer) commands.

The global unique ID may be described in an infoblock of the descriptors.

A first method of information processing according to the invention is comprised of: a memory control step of controlling a memory to store an ID information for identifying an I/O control unit and a global unique ID of a first another information processing device, associating therebetween; and a supply step of supplying the global unique ID of the first another information processing unit under the memory control to a second another information processing device in response to its request.

A software program recorded in a first recording medium according to the invention is comprised of: a memory control step of controlling a memory to store an ID information for identifying a connecting plug and a global unique ID of a first another information processing device associating therebetween; and a supply step of supplying the global unique ID of the first another information processing device under the memory control in the above step to a second another information processing device in response to a request therefrom.

According to the features of the first information processing device, the first information processing method and the first recording medium recorded a software program according to the invention, the memory control is provided for controlling the memory to store the ID information for identifying a connecting plug and a global unique ID of a first another information processing device associating therewith so that the global unique ID of the first another information processing device under the above memory control is supplied to a second another information processing device in response to a request therefrom.

A second information processing device according to the invention in a digital network system including a first another information processing device and a second another information processing device connected via an analog signal line, comprised of: a requesting unit for requesting a transfer of a global unique ID of the first another information processing device which is stored in the second information processing device in association with a connecting plug of the second another information processing device, to the second another information processing device which stores the connecting plug identifier information and the global unique ID of the first another information processing device corresponding thereto; and a determining unit for determining a function of the first another information processing device on the basis of the global unique ID transferred from the second another information processing device in response to the request from the requesting unit.

The second another information processing device may store a text corresponding to a connecting plug, and the request unit may request transfer of the text, and further the information processing device can include a display control unit for controlling display of the text thus transferred.

The digital network can be comprised of the IEEE-1394 serial bus.

The global unique ID can be stored in the descriptor specified by AV/C commands.

The global unique ID can be described in the infoblock of the descriptor.

A second method of information processing according to the invention is for a second information processing device in a digital network system including a first another information processing device and a second another information processing device connected via an analog signal line to exchange analog signals using connecting plugs, the method comprised of: a requesting step for requesting a transfer of a global unique ID of the first another information processing device which is stored in the second information processing device in association with a connecting plug of the second another information processing device, to the second another information processing device which stores the connecting plug identifier information and the global unique ID of the first another information processing device corresponding thereto; and a determination step of determining a function of the first another information processing device on the basis of the global unique ID transferred from the second another information processing device in response to the request from the requesting unit.

The program that is recorded in a second recording medium of the invention, which relates to a second information processing device provided with a plug through which to input or output an analog signal to and from a first another information processing device connected via an analog signal line, includes: a request step for requesting transfer of the global unique ID of the first another information processing device, which is stored in a second information processing unit in association with its connecting plug, to the second another information processing device which stores the plug identifier information and the global unique ID of the first another information processing device corresponding thereto via a digital network; and a determining step for determining a function of the first another information processing device on the basis of the global unique ID transferred from the second another information processing device in response to the request from the request portion.

According to the features of the second information processing device, the second method of information processing and the program recorded in the second recording medium of the invention, for a digital network system including a first and a second another information processing devices further connected via an analog signal line for exchanging analog signals using connecting plugs, the transfer of the global unique ID of the first another information processing device which is stored in the second another information processing device in association with its connecting plug is requested to the second another information processing device which stores the plug ID information and the global unique ID of the first another information processing device corresponding thereto via the digital network so as to be able to determine the function of the first another information processing device on the basis of the global unique ID transferred from the second another information processing device responsive to its request.

### BRIEF DESCRIPTION OF THE DRAWINGS

FIG. 1 is a diagram showing an architecture of a CSR;

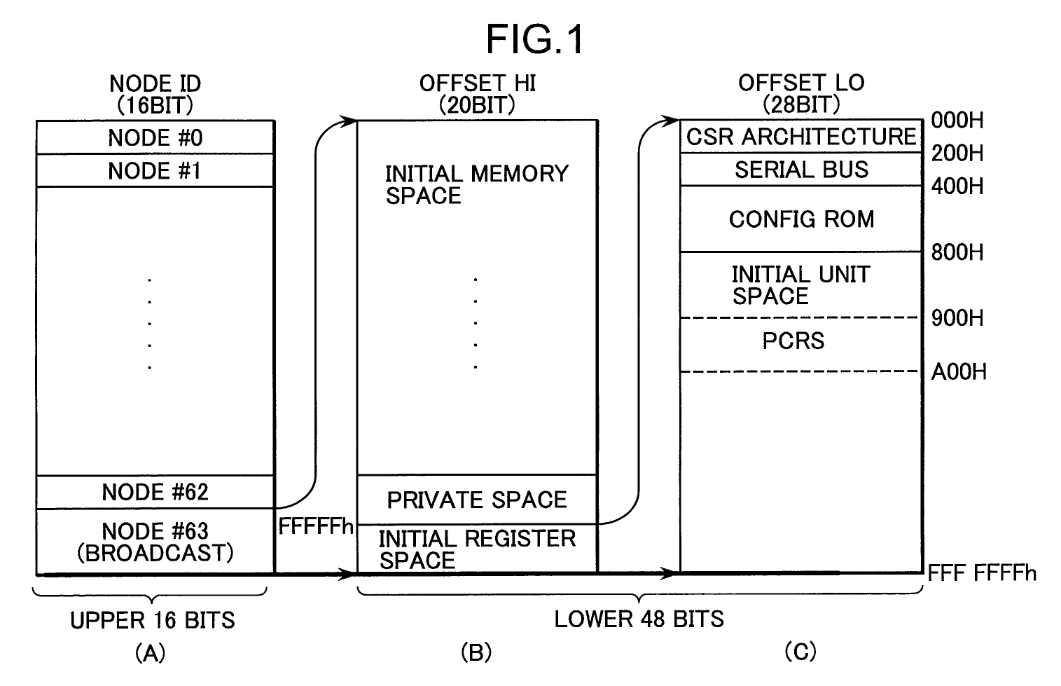

FIG. 2 is a diagram showing a bus_infoblock, a root_directory, and an unit_directory;

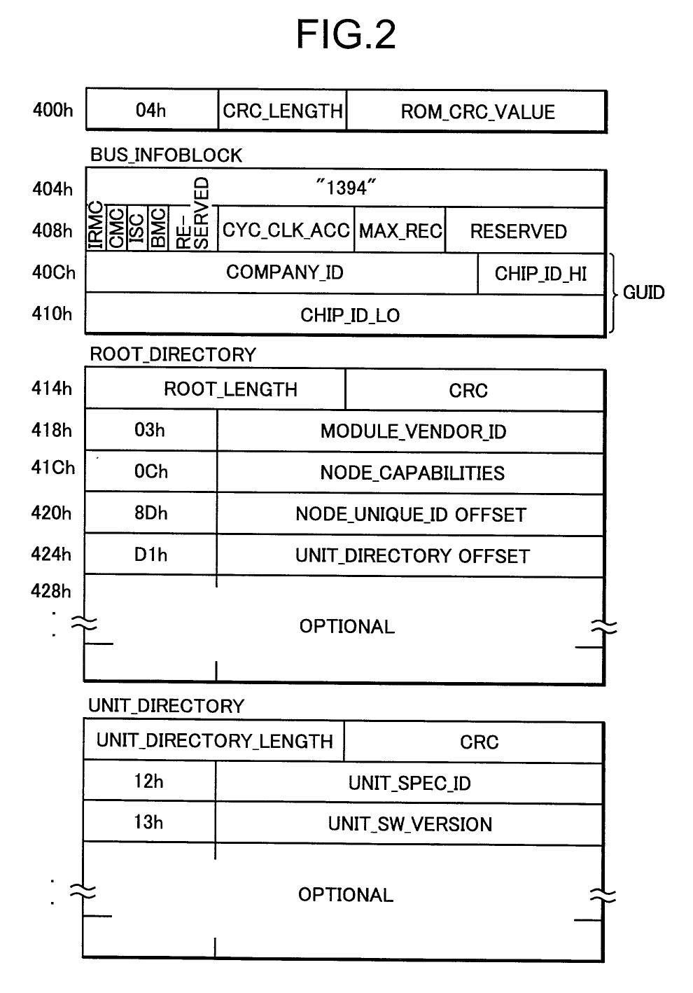

FIGS. 3A and 3B are a diagrams showing architectures of PCRs;

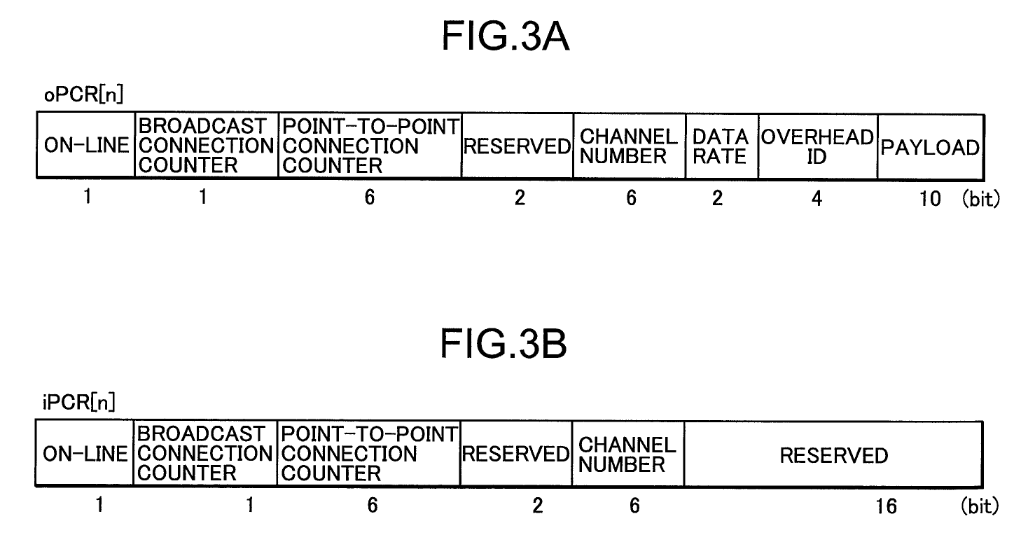

FIG. 4 is a diagram showing an example of embodiments of connections for constructing a home network system comprising an IRD 1, a digital TV 2 and a DVHS 3 according to the invention;

FIG. 5 is a block diagram showing an example of functional arrangements of the IRD 1, the digital TV 2 and the DVHS 3 in the home network system;

FIG. 6 is a diagram for explaining one of a plug descriptor of the present invention;

FIG. 7 is flowchart describing operations of the IRD 1 and the digital TV 2 at the time of execution of an analog connection specifying a processing of the present invention;

FIG. 8 is a flowchart describing process sequences that the DVHS 3 executes for recognizing status of analog connections between IRD 1 and TV 2;

FIG. 9 is a diagram indicating the unit descriptor; and

FIG. 10 is a block diagram showing an example of configurations of a computer 101.

### PREFERRED EMBODIMENTS OF THE INVENTION

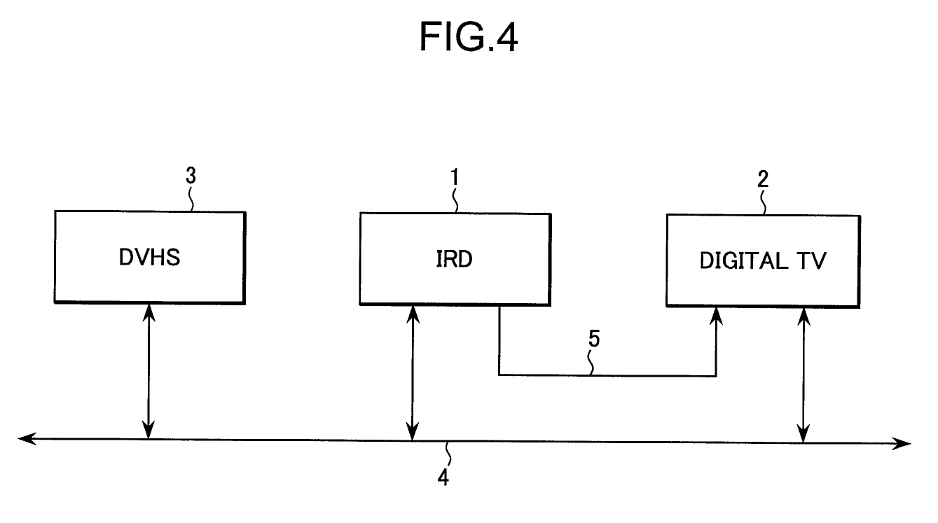

With reference to FIG. 4, there is shown an example of connections for constructing an IEEE-1394 network system embodying the invention, which is comprised of an integrated receiver/decoder (IRD) 1, a digital television (digital TV) 2 and a digital video home system (DVHS: trade mark) 3.

The IRD 1, the digital TV 2 and the DVHS 3 are interconnected via the IEEE-1394 bus. Further, the IRD 1 and the digital TV 2 are connected via an analog signal line 5 so that analog signals output from the IRD 1 are entered into the digital TV 2. More specifically, an analog signal output terminal (not shown) of the IRD 1 is connected with one end of the analog signal line 5, and an analog signal input terminal (not shown) of the digital TV 2 is connected with the other end of the analog signal line 5.

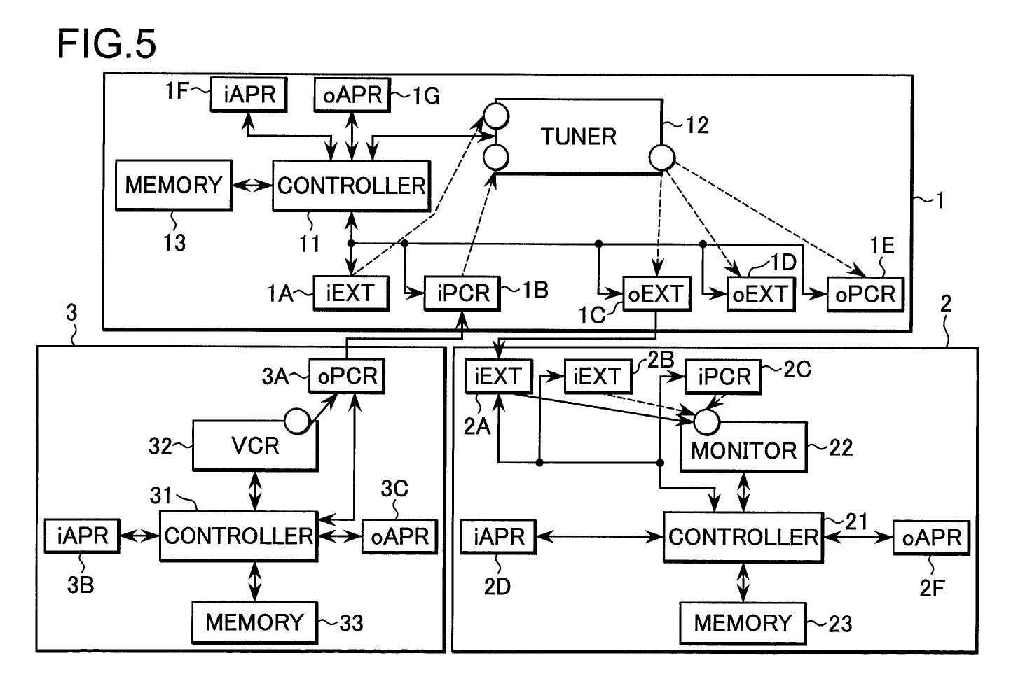

FIG. 5 shows an example of configurations of the IRD 1, the digital TV 2 and the DVHS 3, especially in terms of functions. For the purpose of simplification, only blocks representing main functions of each electronic device are shown in FIG. 5, and only these main functions will be described in the following. However, the functions of each electronic device should not be construed to be limited thereto.

An analog signal input plug (hereinafter referred to as an iEXT (external plug) 1A in the IRD 1 is provided for controlling input of analog signals as to a digital broadcast signal (transport stream) which is modulated and encoded in compliance with the MPEG (Moving Picture Expert Group) 2 Standard, and received by an antenna (not shown) or a digital TV broadcast signal (hereinafter referred to as a DSS stream) which is encoded in compliance with the DSS (Digital Satellite System) Standard.

An input plug iPCR 1B for use of an isochronous transfer is provided for controlling input of isochronous packets (such packets comprise such as a transport stream or the DSS stream) which are transferred, for example, on the IEEE-1394 bus.

An output plug (hereinafter referred to as an oEXT) 1C for analog signals is provided for controlling processes of decoding the DSS stream (hereinafter referred to as a DSS decoding) which is input from the iPCR 1B, for example, and of outputting as an analog signal to an external device. In the case of this example, an analog signal output terminal/plug (not shown) which corresponds to the oEXT 1C is connected to the analog signal line 5. Namely, an analog signal which is the DSS decoded by the oEXT 1C is supplied to the digital TV 2 via the analog signal line 5.

An oEXT 1D is provided for controlling processes of decoding the transport stream (hereinafter referred to as the MPEG decoding) which is entered from a tuner portion 12, for example, and of outputting as an analog signal to an external device. In the case of this example, an analog signal output plug (not shown) which corresponds to the oEXT 1D is not connected with the analog signal line.

An oPCR 1E which is an output plug for the isochronous transfer is provided for controlling generation of the isochronous packets on the basis of digital signals entered from the tuner portion 12, for example, and outputting to the IEEE-1394 bus.

An input plug for an asynchronous transfer (hereinafter referred to as an iAPR (Asynchronous Plug Register)) 1F is provided for controlling input of an the asynchronous packets (for example, a packet comprising a control signal) to be transferred on the IEEE-1394 bus 4.

An output plug for the asynchronous transfer (hereinafter referred to as an oAPR (output Asynchronous Plug Register)) 1G is provided for controlling a process of generating the asynchronous packets on the basis of signals entered from a control portion 11, for example, and outputting to the IEEE-1394 bus 4.

The tuner portion 12 executes processing such as selection, demodulation and the like with respect to a signal entered via the iEXT 1A, and also outputs a processed signal to the oEXT 1C to the oPCR 1E appropriately.

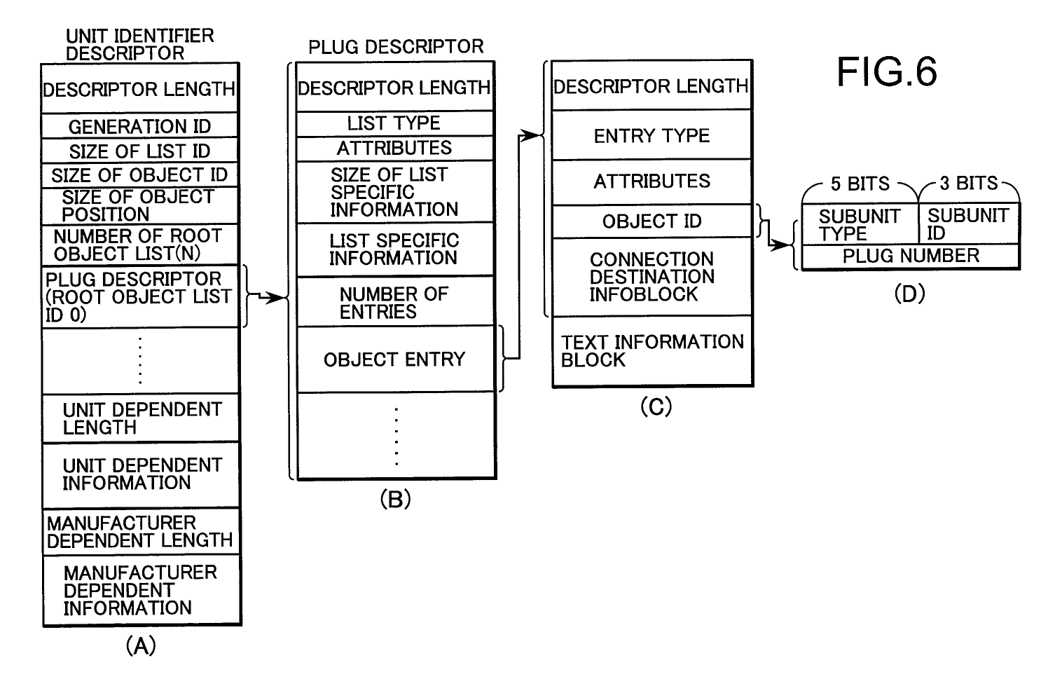

A memory portion 13 stores a “Plug Descriptor” as shown in FIG. 6. This plug descriptor (B) is defined as one of a root object list in an unit identifier descriptor (A) which is specified by an AV/C commands.

In this plug descriptor shown in FIG. 6, there are described a descriptor length, a list type, attributes, a size of list specific information, and a plurality of object entries.

This list type indicates that this descriptor (list) is a plug descriptor. The attributes indicate if an object ID (to be explained later) is described in its object entry or not.

The object entry is provided in the number corresponding to the number of plugs that the IRD 1 has. In each object entry as shown by (C) in FIG. 6, there are described a descriptor length, an entry type, attributes, an object ID, and a connection destination information infoblock.

This entry type indicates if a plug to be specified by its object ID is an input plug or an output plug. The attributes indicate if there is a child list or not. This object ID indicates an ID that is given to its plug (either value of 00h to FFh), which is comprised of a subunit type (5 bits), a subunit ID (3 bits) and a plug number (8 bits) as shown in (D) in FIG. 6.

This subunit type indicates a type of the subunit that has the plug (for example, the tuner portion 12 of the IRD 1), and the subunit ID indicates its identifier number. In case that the plug is owned not by a subunit (a single function) but by a unit (for example, IRD 1), values indicated by subunit type and unit ID become “FFh”. The plug number indicates an identifier number of the plug.

The connection destination information infoblock is comprised of: the connection destination infoblock in which to describe a GUID of an electronic device of connection destination and an object ID of connection destination plug; and text info block in which to describe an appropriate title set up by the user for the plug which is specified by the object ID. Because of use of an infoblock formatting, which is not a type in which the information is described in a fixed field, addition and deletion of the information can be done easily per unit of information.

Now, back to FIG. 5, a control unit 11 of the IRD 1 has a function to control respective portions and units therein. For example, when a DSS stream, which needs the DSS decoding, is entered into the iPCR 1B, the control unit 11 controls the same to be supplied to the oEXT 1C. Thereby, this DSS stream is subjected to the DSS-decoding in the oEXT 1C.

An iEXT 2A and an iEXT 2B in the digital TV 2 have a function to control input of analog signals. In case of this example, because an analog signal input plug which corresponds to the iEXT 2A is connected to the analog signal line 5, the iEXT 2A controls input of analog signals via the analog signal line 5.

The iPCR 2C controls input of the isochronous packets transferred on the IEEE-1394 bus 4, and execution of the MPEG decoding of digital signals constituting these packets.

An iAPR 2D controls input of the asynchronous packets transferred on the IEEE-1394 bus 4.

An oAPR 2F controls a process of generating the asynchronous packets on the basis of signals entered from a control portion 21, and outputting to the IEEE-1394 bus 4.

An monitor processing portion 22 executes processing to display a picture corresponding to signals entered via the iEXT 2A or the iPCR 2C on a display portion (not shown).

An memory portion 23 stores the plug descriptors relating to the plugs owned by the digital TV 2 as shown in FIG. 6. The control unit 21 controls respective portions therein.

An oPCR 3A in the DVHS 3 controls a process of generating the isochronous packets (comprised of the transport stream or the DSS stream) on the basis of signals entered from a VCR portion 32, and outputting to the IEEE-1394 bus 4.

An iAPR 3B controls a process of inputting the asynchronous packets transferred on the IEEE-1394 bus 4.

An oAPR 3C controls a process of generating the asynchronous packets on the basis of signals entered from a control portion 31, and outputting the same to the IEEE-1394 bus 4.

The VCR portion 32 reads out digital signals such as the transport stream or the DSS stream recorded on a recording medium (not shown) installed in the DVHS 3, and outputs the same to the oPCR 3A.

A memory unit 33 stores the plug descriptors as shown in FIG. 6 relating to the plugs owned by the DVHS 3. The control unit 31 controls respective units and portions therein.

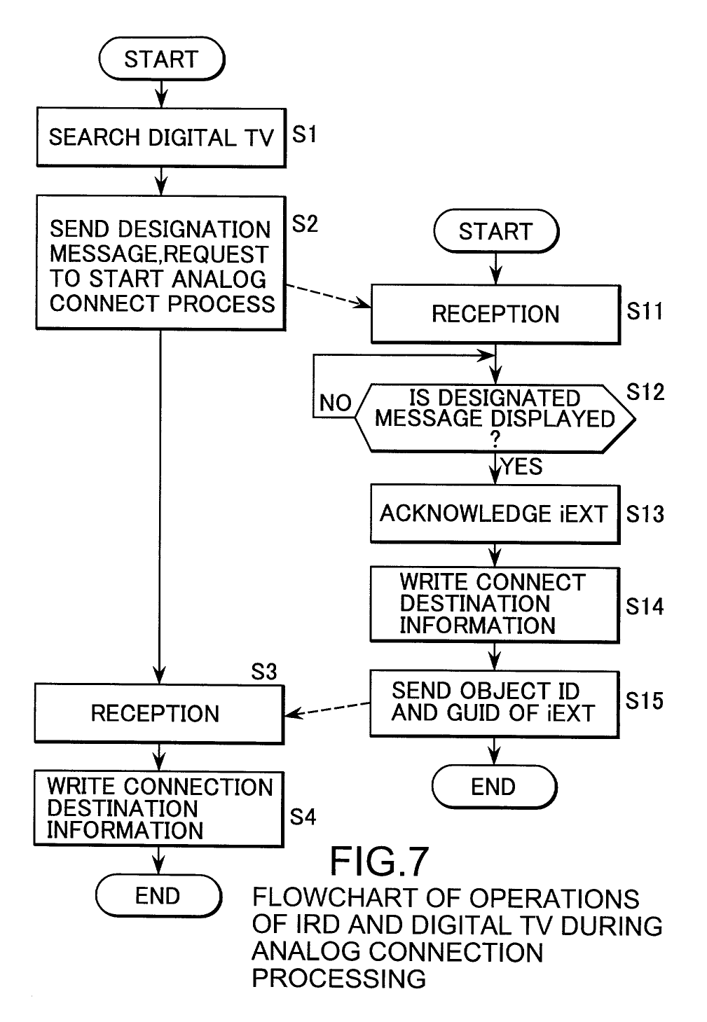

Now, with reference to a flowchart of FIG. 7, a process of specifying a proper analog signal input plug terminal of the digital TV 2 which is to be connected with the analog signal output plug terminal of the IRD 1 (hereinafter referred to as analog connection specifying process) to be executed by the IRD 1 and the digital TV 2 will be described.

For example, as shown in FIG. 4, when the digital TV 2 is to be connected with the IRD 1 via the analog signal line 5, the user operates a remote commander of the IRD 1 (not shown) and instructs the control unit 11 in the IRD 1 to start the analog connection specifying process with respect to the digital TV 2. At this instant, in step S1 in FIG. 7, responsive to an instruction to start the analog connection specifying process, the control portion 11 controls an oAPR 1G to search for the digital TV 2.

More specifically, using the asynchronous transaction which is specified in the ISO/IEC-13213, the IEEE-1394-1995, the IEC-61883-1, and is the IEEE-1394 Standard, an inquiry is issued to each electronic device which is connected to the IEEE-1394 bus 4 whether or not it has a monitor (subunit). The control unit 11 receives a response from each electronic device, and on the basis of this response, searches out the digital TV 2 as an electronic device that has a monitor.

In step 2, the control unit 11 of the IRD 1 sends a predetermined message, for example, “Is a proper analog signal input plug terminal to enter an analog signal from the IRD selected? (hereinafter referred to as specifying message)” to the digital TV 2 via the oEXT 1C (via the analog signal line 5), and also sends a request to start the analog connection specifying process to the digital TV 2 via the oAPR 1G (via the IEEE-1394 bus 4). By way of example, in this start request message, there are included the GUID of the IRD 1 and the object ID of the oEXT 1C.

Upon reception of the request to start the analog connection specifying process via the iPCR 2C, the digital TV 2 starts the steps of processing as indicated in FIG. 7. In step 11, the iEXT 2A of the digital TV 2 receives the specifying message supplied from the IRD 1 via the analog signal line 5.

In the next step of S12, in response to operation by the user of a remote commander (not shown) of the digital TV 2, the control unit 21 of the digital TV 2 controls the iEXT 2A and the iEXT 2B so that signals received by the iEXT 2A and/or the iEXT 2B are output alternatively to the monitor processing portion 22. Thereby, pictures corresponding to the signals supplied from the iEXT 2A and/or the iEXT 2B are displayed, for example, by toggle operation, on a display panel of the digital TV 2.

In the case of this example, because the iEXT 2A is set to receive the specifying message, when the iEXT 2A is under control to output its signals to the monitor processing portion 22, the specifying message is supplied to the monitor portion 33. As a result, the specifying message “Is a proper analog signal input plug terminal for entering analog signals from IRD selected?” is displayed on the display panel. As for the iEXT 2B in this case, because it is not set to receive any signal, even when the iEXT 2B is under control to supply signals to the monitor processing portion 22, no specifying message is displayed on the display panel. Namely, in step S12, the user keeps operating the remote commander until the specifying message is judged to be displayed on the display panel of the digital TV 2.

When the specifying message is judged to be displayed on the display panel of the digital TV 2 through the processing of step S12, the user is able to know that a proper analog input plug terminal of the digital TV 2 for entering analog signals from the IRD 1 is selected, then carry out a predetermined operation with respect to the remote commander of the digital TV 2. Thereby, through step S13, the control portion 21 of the digital TV 2 is enabled to acknowledge that the iEXT (iEXT 2A in this instance) currently under control to output the signals to the monitor processing portion 22 is a correct iEXT which corresponds to an analog signal input plug terminal which is connected to an analog signal output plug terminal of the IRD 1.

In the next step S14, the control unit 21 of the digital TV 2 writes the GUID of the IRD 1 contained in the request message to start the analog connection specifying process received in step S11, as a GUID of a device connected with the digital TV 2 via the analog signal line, into the connection destination infoblock of the object entry, which describes the object ID of the iEXT 2A, in the plug descriptor stored in the memory unit 23, and describes the object ID of the oEXT 1C of the IRD 1 as an object ID of the oEXT which corresponds to the analog signal output plug to be connected with the analog signal input plug which corresponds to the iEXT 2A. Thereby, information is stored in the digital TV 2 indicating that the analog signal input plug of the digital TV 2 to which the iEXT 2A corresponds and the analog signal output plug of the IRD 1 to which the eEXT 1C corresponds are connected. Further, at this time, the user is allowed to attach a name (text) to the iEXT 2A when required. This text entered by means of the remote commander or the like is stored in the text infoblock.

In step S15, the control unit 21 of the digital TV 2 sends the object ID of the iEXT 2A and the GUID of the digital TV 2 to the IRD 1 via the oAPR 2F (the IEEE-1394 bus 4) as a response to the request for starting the analog connection specifying process.

In step S3, the control portion 11 of the IRD 1 receives, as its connection destination information, the GUID and the object ID of the iEXT 2A sent from the digital TV 2 in step S15 via the iAPR 1F.

In the next step S4, the control portion 11 of the IRD 1 writes the GUID of the digital TV 2 which is received in step S3 into the connection destination infoblock of the object entry which describes the object ID of the eEXT 1C, in the plug descriptor stored in the memory portion 13, as a GUID of another device which has analog connection with the eEXT 1C of the IRD 1, then writes the object ID of the iEXT 2A of the digital TV 2 as an object ID of a proper iEXT which corresponds to a proper analog signal input plug terminal to be connected with the analog signal output plug which corresponds to the oEXT 1C of the IRD 1. Thereby, the information is stored in the IRD 1 indicating that its analog signal output plug to which the oEXT 1C of the IRD 1 corresponds is connected with the analog signal input plug to which the iEXT 2A of the digital TV 2 corresponds. The user is also allowed here to add a name (text) to the oEXT 1C and store it in the text infoblock.

As described hereinabove, the analog connection is thus specified according to the invention.

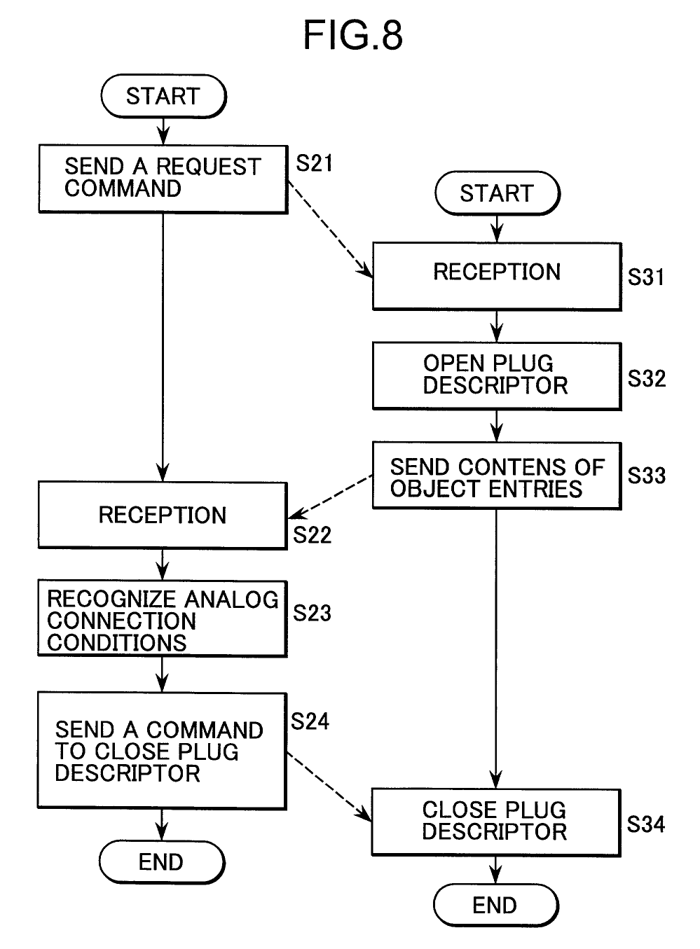

The contents of the plug descriptor are allowed for any of respective electronic devices connected via the IEEE-1394 bus 4 to access to and read. An example of such instances will be described with reference to FIG. 8 and its flowchart, in which steps of operations required for the DVHS 3 to execute for determining which device(s) has analog connection with the IRD 1 are described.

For example, in the case of displaying a picture corresponding to a DSS stream which is read from a recording medium in the DVHS 3 on the display portion of the digital TV 2, because the digital TV 2 has no DSS decoding function, it is necessary to supply analog signals that have been DSS-decoded, for example. Further, because the DVHS 3 neither has a DSS decoding function, it is arranged, as indicated by solid arrows in FIG. 5, such that the DSS stream read out in the DVHS 3 (VCR portion 32) is supplied to the IRD 1 (via the oPCR 3A) where to be subjected to the DSS decoding (supplied via the iPCR 1B to the oEXT 1C, where DSS decoded), then analog signals obtained consequently are supplied to the digital TV 2 (via the oEXT 1C). As a result, a picture which corresponds to the DSS stream read out in the DVHS 3 is displayed on the display portion of the digital TV 2 (analog signals entered via the iEXT 2A are input to the monitor processing portion 22, where to be processed for displaying pictures corresponding to the analog signals). Namely, in the above case, the DVHS 3 needs to judge whether or not the IRD 1 has an analog connection with the digital TV 2, and also whether or not the digital TV 2 has a display function.

With reference to FIG. 8, in step S21, the control portion 31 of the DVHS 3 sends a request command to the IRD 1 via the oAPR 3C (IEEE-1394 bus 4), requesting to open the plug descriptor and read out the object entry thereof in which the object ID of the analog output plug oEXT (oEXT 1C and oEXT 1D) is described.

In step S31, the control portion 11 of the IRD 1 receives the request command via the iAPR 1F, which is sent from the DVHS 3 in step S21. Then, in step S32, it opens the plug descriptor stored in the memory portion 13 in response to the command. Then, in step S33, the control portion 11 of the IRD 1 reads out respective object entry items which describes the object IDs of the analog output plug oEXT 1C and oEXT 1D from the plug descriptor opened in step S32, and sends the contents thereof to the DVHS 3 via the oAPR 1G.

The control portion 31 of the DVHS 3, when it receives the contents of the object entry items from the IRD 1 via the iAPR 3B in step S22, is enabled to recognize a status of analog connections currently effective on the basis of its reception in step S23. In this case, because that in the object entry which describes the object ID of the oEXT 1C of the IRD 1, there is described the connection destination information indicating that the analog signal output plug which corresponds to the oEXT 1C and the analog signal input plug which corresponds to the iEXT 2A of the digital TV 2 are connected (refer to step S14 in FIG. 7), the control portion 31 of the DVHS 3 is thereby assured to be able to confirm that the IRD 1 has the analog connection with the digital TV 2. Further, because the GUID of the digital TV 2 is stored as the connection destination GUID, the control portion 31 of the DVHS 3 is able to confirm from this GUID that the digital TV 2 has a monitor (display function).

Then, when a command to close the plug descriptor is sent from the control portion 31 of the DVHS 3 to the IRD 1 in step S24, the control portion 11 of the IRD 1 executes a process to close the plug descriptor in step S34.

When it is confirmed as described above that an analog connection is established between the IRD 1 and the digital TV 2, the DVHS 3 supplies, for example, a DSS stream read from the recording medium to the IRD 1. The DSS stream supplied from the DVHS 3 to the IRD 1 is DSS-decoded, then analog signals obtained as a result are supplied to the digital TV 2. Then, the digital TV 2 displays a movie picture corresponding to the analog signals supplied from the IRD 1 on its display. Further, as described above, at the time when the IRD 1 decodes the DSS stream supplied from the DVHS 3 and transfers to the digital TV 2, the GUID of the DVHS 3, the object ID of the oPCR 3A and the object ID of the oEXT 1C are stored in the connection destination infoblock of the object entry which describes the object ID of the iPCR 1B in the plug descriptor which is stored in the memory portion 13, and also the object ID of the iPCR 1B is added to the connection destination infoblock of the oEXT 1C. Thereby, every one of electronic devices is allowed to confirm merely by looking at the plug descriptor of the IRD 1 that the signal from the DVHS 3 (DSS stream) is supplied to the digital TV 2 via the IRD 1 along the data path from the oPCR 3A, the iPCR 1B, the oEXT 1C and the iEXT 2A.

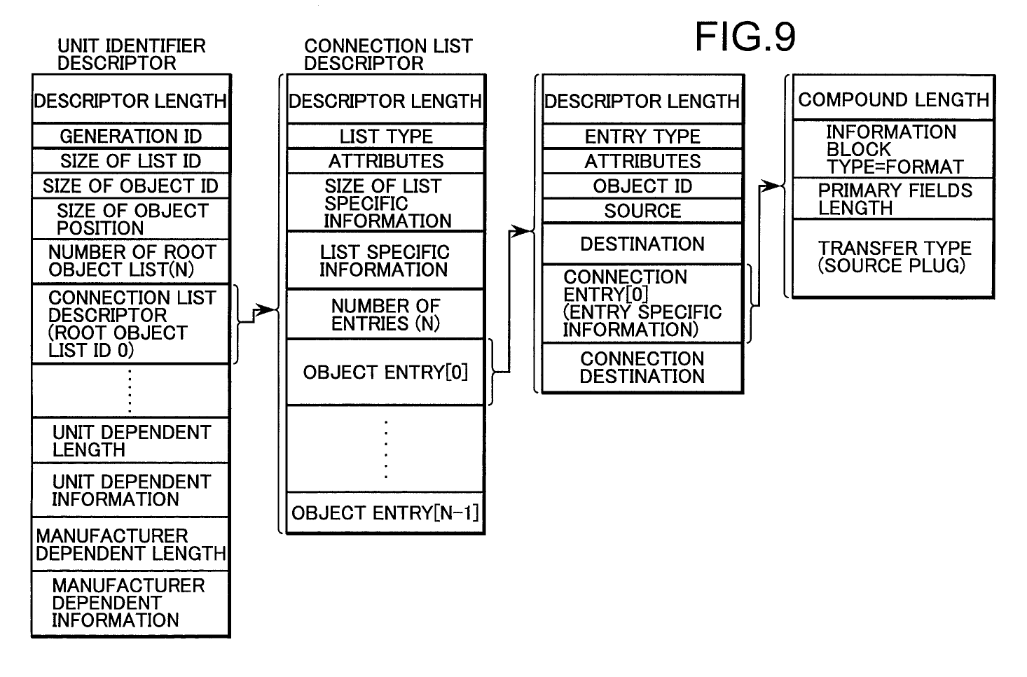

The above description of the invention is made by assuming that each electronic device stores the plug descriptor as shown in FIG. 6, however, it is not limited thereto, and the connection list descriptor as shown in FIG. 9 may be stored to the same effect. This connection list descriptor is also specified as one of the root object lists.

In the case of FIG. 9, a connection destination information is described in the object entry provided in the connection list descriptor. As this connection destination information, all patterns (combinations) theoretically connectable between sources and destinations are stored in advance together with an indication which plug is at use. In this object entry, there is provided a connection entry in which information is described indicating which format (such as the MPEG format, the DSS format or the like) data can be input or output through which plug.

The above-mentioned series of operations can be implemented by hardware, however, they can be implemented also by a computer software. In case these series of operations are to be implemented by a computer software, a computer program that constitutes the software is installed in a computer and is executed thereby functionally implementing the above-mentioned IRD 1, the digital TV 2 and the DVHS 3.

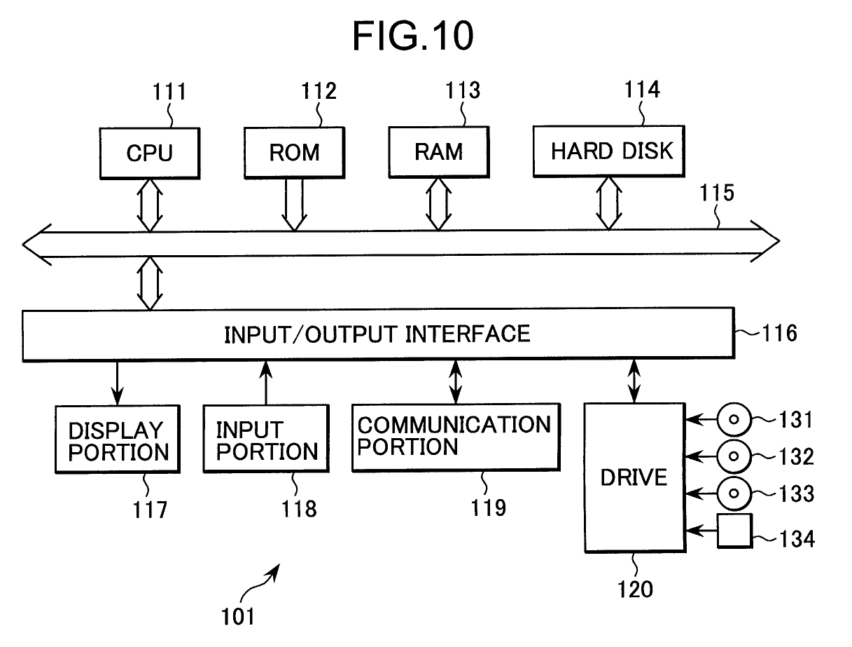

FIG. 10 is a block diagram showing a configuration of a computer 101 which functions as the above-mentioned IRD 1, the digital TV 2 and the DVHS 3 according to an embodiment of the invention. A CPU (Central Processing Unit) 111 has an input/output interface 116 connected thereto via a bus 115. Upon entry of a command from the user using a keyboard, a mouse or the like via the I/O interface 116, the CPU 111 loads the program stored in a ROM (Read Only Memory) 112, a hard disk 114, or a drive 120 which installs recording media such as a magnetic disk 131, an optical disk 132, a magneto-optical disk 133 or a semiconductor memory 134, into the RAM (Random Access Memory) 113 and executes the program. Thus, the foregoing various processing operations (such as those shown in flowcharts of FIGS. 7 and 8) are executed. Further, the CPU 111 outputs a result of such processing operations to a display portion 117 comprising a LCD (Liquid Crystal Display) or the like via the I/O interface 116 when required. By way of example, these programs may be pre-stored in the hard disk 114 or the ROM 112 to be supplied integral with the computer 101 to the user, may be supplied as package media stored in the magnetic disk 131, the optical disk 132, the magneto-optical disk 133, the semiconductor memory 134 or the like, or may be supplied downloading from a satellite, a network or the like to the hard disk 114 via a communication portion 119.

By way of example, the steps of description of the computer program to be provided by the recording media according to the invention should be construed to include not only those which are executed in time sequences in the order as described above but also those which are to be executed in parallel or discretely.

Further, the system defined in this specification refers to an integrated system which is comprised of a plurality of devices.

As described hereinabove, according to the features of the first information processing device, the first information processing method and the first computer program stored in the first recording medium of the invention, the control of the analog connections in the system has become substantially simplified and easy because that the plug identifier information in the system and the global unique ID of the first another information processing device which is a destination of its analog connection are stored in association therewith in memory, and the memory is controlled so that the global unique ID of the first another information processing device is supplied to the second another information processing device upon its request to ascertain that the analog connection is established in the system.

According to the features of the second information processing device, the second information processing method and the second program stored in the second recording medium of the invention, the second information processing device having the analog signal line connected with its first another information processing device and the analog signal input/output plug to be connected therewith, wherein its second another information processing device stores the plug identifier information associated with the global unique ID of the first another information processing device corresponding thereto, and transfers the global unique ID of the device corresponding to the plug when requested of its transfer via the digital network so as to be able to determine the function of the first another information processing device and simplify the control of analog connections in the system.

What is claimed is:

1. An information processing device having a global unique ID which includes a self identifier information for identifying its entity and a function identifier information for identifying its function, said information processing device being connected with other information processing devices via a digital network, comprising:
an input/output control unit for controlling input or output of analog signals to be exchanged between said information processing device and a first another information processing device connected via an analog signal line;
a memory unit for storing an identifier information for identifying said input/output control unit and said global unique ID of said first another information processing device corresponding thereto; and
a supply unit for supplying said global unique ID of said first another information processing device which is stored in said memory unit to a second another information processing device upon its request.

2. The information processing device according to claim 1, wherein
said memory unit further stores a text corresponding to said input/output control unit.

3. The information processing device according to claim 1, wherein
said digital network is an IEEE-1394 digital serial bus.

4. The information processing device according to claim 3, wherein
said memory unit stores a descriptor specified by AV/C commands.

5. The information processing device according to claim 4, wherein
said global unique ID is described in an info block of said descriptor.

6. An information processing method for an information processing device having a global unique ID including a self identifier information for identifying its entity and a function identifier information for identifying its function, connected with other information processing devices via a digital network, and having an input/output control unit for controlling input or output of analog signals to be exchanged between the same and a first another processing device, said method comprising:
a step of memory control for storing said identifier information for identifying said input/output control unit in association with said global unique ID of said first another information processing device corresponding thereto; and
a step of supplying said global unique ID of said first another information processing device under the memory control to a second another information processing device upon its request.

7. A recording medium which records a computer readable program for use of an information processing method in an information processing device having a global unique ID including a self identifier information for identifying its entity and a function identifier information for identifying its function, connected to other information processing devices via a digital network, and having an input and/or output plug to establish a connection for exchanging analog signals between a first information processing device and a first another information processing device, said information processing method comprising:
a step of memory control for storing a plug identifier information for identifying said plug and said global unique ID of said first another information processing device corresponding thereto; and
a step of supplying said global unique ID of said first another information processing device under the memory control to a second another information processing device upon its request.

8. An information processing device having a global unique ID which includes a self identifier information for identifying its entity and a function identifier information for identifying its function, said information processing device being connected with other information processing devices via a digital network, comprising:
a unit for requesting transfer of a global unique ID of a first another information processing device to a second another information processing device which has a connecting plug and stores said global unique ID of said first another information processing device associated with the connecting plug thereof, by use of which analog signals are exchanged therebetween via an analog signal line, said requesting being made via said digital network; and
a unit for determining a function of said first another information processing device on the basis of said global unique ID thereof which said second another information processing device transferred responding to the request.

9. The information processing device according to claim 8, wherein
said second another information processing device stores a text corresponding to said connecting plug;
said requesting unit request transfer of said text; and
said the information processing device further comprises a display control unit for controlling a display of said text transferred thereto.

10. The information processing device according to claim 8, wherein
said digital network is an IEEE-1394 digital serial bus.

11. The information processing device according to claim 10, wherein
said global unique ID is stored in a descriptor which is defined in AV/C commands.

12. The information processing device according to claim 11, wherein
said global unique ID is described in an infoblock in said descriptor.

13. An information processing method for an information processing device having a global unique ID including a self identifier information and a function identifier information for identifying a function of its own, connected via a digital network with other information processing devices, the method comprising:
a step of requesting transfer of a global unique ID of a first another information processing device to a second another information processing device which has a connecting plug for analog signals and stores a connecting plug identifier information for identifying said connecting plug in association with said global unique ID of said first another information processing device corresponding thereto, via said digital network; and
a step of determining a function of said first another information processing device from said global unique ID thereof transferred from said second another information processing device in response to said request.

14. A recording medium storing a computer readable program for an information processing device having a global unique ID including a self identifier information and a function identifier information for identifying a function of its own, connected via a digital network with other information processing devices, the recording medium recording process including the steps of:
requesting transfer of a global unique ID of a first another information processing device to a second another information processing device which has a connecting plug for analog signals and stores a connecting plug identifier information for identifying said connecting plug in association with said global unique ID of said first another information processing device corresponding thereto, via said digital network; and
determining a function of said first another information processing device on the basis of said global unique ID thereof transferred from said second another information processing device in response to said request.
